(19) United States
(12) Patent Application Publication
(10) Pub. No.: US 2026/0191349 A1
(43) Pub. Date: Jul. 9, 2026

(54) Compartment System with Damage Detection

(71) Applicant: Deutsche Post AG, Bonn (DE)

(72) Inventors: Dennis Kamb, Rösrath (DE); Ulf Nägel, Prüm (DE); Christian-Jochum Franke, Bonn (DE)

(21) Appl. No.: 19/426,605

(22) Filed: Dec. 19, 2025

(30) Foreign Application Priority Data
Dec. 20, 2024 (DE) 10 2024 139 380.7

(51) Int. Cl. A47G 29/14; A47G 29/30; G01K 3/14

(52) U.S. Cl. CPC A47G 29/141; A47G 29/30; G01K 3/14; A47G 2029/145; A47G 2200/066; A47G 2200/166

(57) ABSTRACT

A compartment system with a plurality of compartments for inserting and removing packages and a plurality of flaps that can be adjusted between a closed position for closing the respective compartment and a release position for releasing the respective compartment to insert and remove packages. In order to reduce the logistical effort resulting from damaged packages, it is provided that at least one sensor for detecting at least one measurement signal relating to the package inserted into the compartment is assigned to at least one compartment, that the sensor is connected to an evaluation unit for estimating the probability of possible minimum damage to the package placed in the compartment based on the detected measurement signal, and that the evaluation unit is connected to a control device for controlling the compartment system depending on the probability of possible minimum damage to the package.

### CROSS-REFERENCE TO RELATED APPLICATION

This application claims priority to German Patent Application No. 102024139380.7 filed Dec. 20, 2024, the disclosure of which is hereby incorporated by reference in its entirety.

### BACKGROUND OF THE INVENTION

### Field of the Invention

The invention relates to a compartment system with a plurality of compartments for inserting and removing packages and a plurality of flaps that can be adjusted between a closed position for closing the respective compartment and a release position for releasing the respective compartment for inserting and removing packages.

### Description of Related Art

Compartment systems of the type mentioned are used in a variety of ways, for example in the form of locker or parcel compartment systems. An example of a compartment system is a parcel station, which is used for receiving or sending packages, in particular postal items. When a user receives packages, these are placed in different compartments of the compartment system by an operator, such as a supplier or delivery service. After the packages have been placed in the compartments, the compartments are closed by means of flaps, which may also have the form of a door, and the flaps are then locked. To reopen the flap, the user must identify themselves as authorized to do so, for example with a code. This code can be, for example, a barcode, DataMatrix code, or QR code. Other types of authentication are also possible, such as an RFID chip or magnetic strip, which can be applied to a card similar to a credit card if required. The user is also notified that a package is ready for collection in the compartment system and, for example, the QR code required to collect the package is sent to them. The user can then open the flap of the compartment in which the package is ready for collection and remove the package. To send a package, the user can unlock a flap of the compartment system and then open it to place the package to be sent in the corresponding compartment. The user can then close the compartment and lock the corresponding flap. If necessary, the user of the compartment system can also provide information about the package, such as information about the sender, the recipient, or the type of package or shipment.

Packages of the type mentioned are typically formed by goods packed in packaging materials. The packaging materials can preferably be cartons, bags, or pouches. Which packaging material is used in each case usually depends on the type and size of the goods to be packaged, which are themselves usually goods suitable for insertion into a compartment system.

In practice, it often happens that damaged packages are found in the compartments. Both the packaging materials and the packages themselves may be damaged. In some cases, both the packaging materials and the packaged goods are damaged. In particular, packages with damaged packaging materials can easily cause damage to the packaged goods during further transport. In many cases, transporting damaged packaged goods is also unnecessary because the packages are usually rejected and returned. Often, a new package must then be sent so that the user receives the desired packaged goods intact. In addition, it is often annoying for the user to go to a storage facility only to pick up a package in which the packaged goods are damaged and cannot be used as intended.

Therefore, the present invention addresses the problem of forming and developing the compartment system of the type mentioned at the outset and explained in more detail above in such a way that the logistical effort resulting from damaged packages can be reduced.

### SUMMARY OF THE INVENTION

This problem is solved in a compartment system described herein in that at least one sensor for detecting at least one measurement signal relating to the package placed in the compartment is assigned to at least one compartment, the sensor is connected to an evaluation unit for estimating the probability of possible minimum damage to the package placed in the compartment based on the detected measurement signal, and the evaluation unit is connected to a control device for controlling the compartment system depending on the probability of possible minimum damage to the package.

The compartment system comprises at least one compartment which is monitored by means of at least one sensor in order to be able to derive a statement from the measurement signal of this at least one sensor as to whether a package placed in the compartment is likely to have minimum damage which makes a certain behavior of the compartment system appear appropriate. In order to trigger this behavior of the compartment system, the probability does not have to be determined quantitatively, and certainly not precisely. In many cases, a qualitative assessment of the corresponding probability will be sufficient. A more precise determination of the probability of a certain minimum damage can, of course, still be provided for. It should be noted that the damage to the package, which may be expressed in damage to the packaging material and/or the packaged goods, does not have to be measured directly, which is why measurement with the at least one sensor will regularly only allow a probability of a certain minimum damage to be determined.

In addition, the minimum damage will not normally be an exact quantitative value. If the packages vary greatly, it is difficult or impossible to specify an exact minimum damage for all possible packages above which a certain behavior of the compartment system is indicated. The minimum damage will therefore preferably be defined in a fairly general way and independently of a specific packaging material and/or packaged goods, so that the compartment system can be operated in the desired manner for different packages. In addition, according to the invention, the minimum damage and the probability of this minimum damage occurring will preferably be selected in such a way that only very significantly damaged packages are very likely to cause the compartment system to exhibit a predetermined behavior. In many cases, it is more acceptable to allow accidentally significantly damaged packages to go undetected than to treat undamaged packages as if they were significantly damaged.

The assessment of how likely it is that the package placed in a specific compartment of the compartment system has suffered minimum damage can be carried out directly by an evaluation unit of the compartment system. For this purpose, the at least one measurement signal relating to the package placed in the compartment, which has been determined by the at least one sensor assigned to the compartment in question, is forwarded from the sensor to the evaluation unit. The compartment system therefore comprises at least one suitable connection between the at least one sensor and the evaluation unit. In addition, the evaluation unit is connected by means of a suitable connection to a control device which can control the compartment system depending on the probability of possible minimum damage. It should be noted that the evaluation unit and the control device do not have to be spatially separate units, but can be combined into a single unit, in particular in a common housing.

It is also not necessary for the evaluation unit of the compartment system to perform all the steps required to estimate the probability of minimum damage to a package itself. For this purpose, the evaluation unit can also use a central processing unit that is decoupled from the compartment system and performs at least some of the aforementioned steps, preferably for a plurality of different compartment systems. The central processing unit may be a computer center, a monitoring device, and/or a server, wherein the processing unit preferably accesses a common database to estimate the probability of minimum damage to the packages of different compartment systems. When using a central processing unit, the evaluation unit should at least collect and process the measurement signals from the at least one sensor and forward these to the central processing unit. The central processing unit can send the information determined based on this data back to the compartment system, in particular to the evaluation unit or directly to the control device. As a result, the connection between the evaluation unit and the control device is provided directly in the compartment system or via the central processing unit. Regardless of this, the connections do not have to be physical, but can also be wireless. The relevant information should be communicated between the evaluation unit and the control device. The means by which this is to be done in individual cases can be freely chosen in many areas. The central processing units of the type mentioned are generally known from the prior art and therefore do not require further detailed explanation here.

Regardless of the type of evaluation unit, if, for example, the evaluation unit considers a package to be damaged to a minimum degree with sufficient probability, the control device can refuse to accept this package into the compartment system. For example, a process intended for the insertion of undamaged packages can be terminated prematurely before all the steps associated with the insertion of the package into the compartment system have been completed. It is possible, for example, that the flap of the corresponding compartment is not closed and/or locked. The user will then not leave the package in the compartment system, but take it back with them so that it does not fall into the wrong hands. This applies in particular if the user receives direct or indirect notification from the compartment system that the package has been identified as damaged and is therefore being refused.

In this context, the term “user” can refer to both an operator of the compartment system, such as a supplier or delivery service, and a user who removes system from the compartment system packages addressed to them and transported to the compartment or places packages addressed to third parties in the compartment system in order to be transported away. The user can therefore be understood as the end customer, while the operator can be understood as a service provider used by the users. In this case, it is appropriate to combine users and operators into the term “user,” as it is often irrelevant, or at least not significantly relevant, whether the interaction of the compartment system takes place with the operator or the user. The use of the collective term “user” therefore simplifies understanding in this case.

Alternatively or additionally, it is conceivable that, in the event that the evaluation unit, with or without recourse to a central processing unit, considers a package to be damaged to a sufficient degree, the control device will initiate the return of the package without the user having to go to the compartment system, and without the user having to remove the package from the corresponding compartment of the compartment system and inspect it. If, for example, the package has been damaged on its way to the compartment system, the user can be spared the trouble of picking up the package. Instead, it can be treated as if it had been placed in the compartment system for the purpose of being returned. If necessary, the user can be informed of this by the control device so that they can inform the compartment system that they do not agree to the return shipment, but would rather collect the package, even if it is highly likely that it is so badly damaged that the contents can no longer be used as intended.

The control device may also be configured to communicate information to the user of the compartment system based on the probability of possible minimum damage to a package. For this purpose, the compartment system may be configured to display this information on an indicator of the compartment system and/or send it to a communication device, in particular a mobile device, of the user. In addition, an acoustic signal may be emitted by the compartment system.

In a first particularly preferred embodiment of the compartment system, the control device is configured to communicate information to the operator based on the probability of possible minimum damage to a package. This communication can take place in different ways. For the sake of simplicity, the compartment system can, for example, be configured to display the information on an indicator of the compartment system and/or send it to a communication device, in particular a mobile device, of the operator. If the information is intended for an operator who is in the process of placing a package in the compartment system, it may be appropriate to display the information on a display or similar device. In addition, an acoustic signal can be emitted from the compartment system. If, on the other hand, the operator still has to come to the compartment system to collect the package, it may be advisable, for example, to send the information to a communication device of the operator, such as a mobile communication device, for example a mobile phone. Operators in this context include, for example, suppliers or delivery personnel. These or other operators can be understood as not only placing packages in the compartment system, but also, alternatively or additionally, removing packages placed in the compartment system by users for transport from the corresponding compartments.

Alternatively or additionally, the control device may be configured to communicate information to the user of the compartment system assigned to the package based on the probability of possible minimum damage to a package. This communication can take place in various ways. For the sake of simplicity, the compartment system can, for example, be configured to display the information on an indicator of the compartment system and/or send it to a communication device, in particular a mobile device, of the user. If the information is intended for a user who is in the process of placing a package in the compartment system, it may be appropriate to display the information on a display or similar device. In addition, an acoustic signal can be emitted from the compartment system. If, on the other hand, the user has yet to come to the compartment system to collect the package, it may be appropriate, for example, to send the information to a communication device of the user, such as a mobile communication device, for example a mobile phone. The users in this case could be, for example, the recipients of the packages.

Regardless of this, the control device may be configured to reject the acceptance of the at least one package by the compartment system based on the probability of possible minimum damage to a package. This may prevent unnecessary transport of the package, since in such cases it can be assumed that the package will be returned anyway after transport due to significant damage. Refusal of acceptance can be achieved by forming the control device to block the locking of a flap assigned to a specific compartment based on the probability of possible minimum damage to a package. Alternatively or additionally, the control device can also be configured to block or initiate the unlocking of a flap assigned to a specific compartment.

For example, it may be provided that damage to a package is detected in a special compartment of the compartment system, which is not intended and/or equipped for permanent storage of the package. If, for example, suspected significant damage to the package is detected in this compartment, the unlocking of the flaps of empty compartments can be blocked. In this case, the user is unable to place the package in a compartment intended for storing the package. If, on the other hand, a package is only inspected for possible damage after it has been placed in a compartment and after the flap assigned to the compartment has been locked in the closed position, the flap can be forcibly unlocked again if significant damage to the package is suspected. Even then, the user is prevented from leaving the package in the compartment. In such a case, the package should be inspected for damage before the user has completed the insertion process, for example, before the last entry has been made at the compartment system. This ensures that the user is still on site after the package has been inspected for damage in order to take the package back with them.

If necessary, the control device can be configured to lock and/or unlock a flap assigned to a specific compartment only depending on at least one predetermined action by a user detectable by the control device. This ensures that the packages in the compartments are handled in a predetermined manner, depending on whether or not the packages are likely to be significantly damaged. In the event of significant damage, for example, at least the proper acceptance of the package can be refused. For example, the control device does not open a compartment for storing the package, or the compartment containing the package is not closed and/or the flap assigned to this compartment is not locked. If the flap has already been closed after insertion, the control device can unlock and/or open the flap again. In addition to preventing the flap from closing and/or locking and to forcibly unlocking and/or opening it, the compartment system can also emit a visual and/or acoustic signal to indicate to the user that the desired process of inserting the package has not been carried out correctly. The control device may also, if necessary after confirmation by the user, reduce the sum insured for the package and/or increase the shipping costs. The control unit can also cause the package to be regarded and treated as a return. In other words, the package can be sent back, if necessary after prior confirmation by the user, who can still collect the package from the compartment system if confirmation is refused.

For simplicity's sake, the user's action that can be recorded by the control device can be an input at a control unit, such as a terminal, at the compartment system. Alternatively or additionally, it is also conceivable that the user sends information to the compartment system or to an external receiving unit that interacts with the compartment system. The receiving unit can be decoupled locally from the compartment system. For example, an input can be made in a mobile phone app. This is then processed in a central processing unit, wherein the central processing unit can exchange information with the specialist system. In this way, for example, information can be sent to the control device of the specialist system without having to enter the information directly at the specialist system. Of course, the information can also be sent directly to the control device of the compartment system. In this case, the integration of a central processing unit is not absolutely necessary. The information sent directly or indirectly to the control device is preferably sent wirelessly by the user, for which the user can preferably continue to use a mobile phone.

In many cases, it may prove expedient for the user to be able to choose from various options regarding the further handling of a package, especially if the package has been assessed by the evaluation unit, with or without recourse to a central processing unit, as having a sufficient probability of having suffered minimum damage. The user can then react relatively flexibly to the fact that the corresponding package has been identified as presumably damaged. The user action mentioned above, which is recorded by the control device, can therefore be a corresponding selection of one of the options provided. In a simple case, the options for selection by the user are suggested and displayed and/or transmitted by the compartment system. However, this is not mandatory, especially if communication takes place between the user and a processing unit located at a distance from the compartment system.

In a simple case, the compartment system or another unit may also simply request confirmation of a further action, which is accomplished by means of the action detectable by the control device. This is particularly useful if the user does not have several options to choose from. In such a case, the action detectable by the control device can also be performed in the manner described above.

In order to reliably detect and assess whether a package is excessively damaged, the at least one sensor may be an acoustic sensor, in particular a microphone, an electromagnetic sensor, an optical sensor, in particular a camera, a mechanical sensor, and/or a thermal sensor, in particular a thermometer. In this way, measurement signals can be recorded which can be evaluated in a manner suitable for assessing damage.

It may also be advantageous if the at least one sensor is a moisture sensor. The moisture sensor can be configured and arranged in such a way that it detects any liquid that may leak from the package. If necessary, this can be done using resistive or capacitive sensors known from the prior art. It is also conceivable that the at least one compartment has a base plate with wires, in particular wire coils. If conductive liquid leaks, individual wires or wire coils can then be short-circuited by the liquid, so that the electrical resistance drops sharply and thus signals the escape of liquid.

The at least one acoustic sensor can, for example, be configured to detect noises generated when a package is placed in a specific compartment of the compartment system and to forward these to the evaluation unit. If a package containing damaged goods, such as glass, is placed in the corresponding compartment of the compartment system, a clinking or similar sound may be heard, which may indicate that the goods are damaged. If necessary, it can also be detected that the package was damaged by being placed in the compartment improperly. It can then be concluded that the user is likely to be responsible for the damage. The measurement signal from the at least one acoustic sensor can be evaluated by the evaluation unit with or without recourse to a central processing unit using pattern recognition to estimate the probability of minimum damage. The actual pattern recognition can be performed in the central processing unit so that less computing power and no corresponding database need to be maintained in the respective compartment system.

The pattern recognition is then based, for example, on the fact that the noises recorded when damaged packages are placed in the corresponding compartments have been determined in advance. It is also conceivable to record noises in advance from an undamaged package that is only damaged when it is improperly placed in the corresponding compartment of the compartment system. If sufficient images are available for a sufficient number of packages, patterns can be identified in the corresponding noises, in particular by means of artificial intelligence, which indicate damage to the packaged goods. If these patterns are also recognized in currently recorded measurement signals, it can be concluded that the package placed in a compartment has been damaged accordingly. The damage preferably affects the packaged goods, since the packaging materials of packages typically do not emit any special and/or significant noises when placed in a compartment.

Alternatively or additionally, at least one optical sensor may be provided to generate images of a package placed in a specific compartment of the compartment system. This allows, for example, the size of the package to be determined in at least one spatial direction and/or address information attached to the package to be recognized. In addition, the images of a package captured by the at least one optical sensor can be used to determine whether the package is likely to be significantly damaged, for example if the package is deformed. The measurement signal from the at least one optical sensor can be forwarded to the evaluation unit. In this case, too, the evaluation unit can perform pattern recognition with or without recourse to a central processing unit in order to derive the probability of minimum damage. The pattern recognition is based on reference patterns from images of damaged packages. If such patterns are recognized in the current images, this may indicate significant damage to the packaging and/or the packaged goods. The actual pattern recognition can be performed centrally in the central processing unit to save computing power and a corresponding database in the respective compartment system.

The at least one optical sensor may be, for example, a camera, such as a 3D camera, wherein 3D cameras display the gray scales or color values of the recorded packages. However, a scanner for scanning the packages, in particular in the form of a six-sided scanner and/or a line scanner, in particular an RGB line scanner, and/or a volume scanner, to which the at least one compartment is assigned, is also preferably used. Then, the evaluation unit can preferably be configured to determine the type, size, and/or condition of the inserted packages based on the scanner images, with or without recourse to a central processing unit. Laser systems for distance determination and thus scanning of the surface of the packages are also conceivable. Such systems can be, for example, LiDAR systems (light detection and ranging systems), even if these will generally be less preferred for cost reasons. These can be relevant characteristics that can help to better evaluate the measurement signals recorded by other sensors with regard to possible damage. For example, reference patterns recorded on packages of the same type, size, and/or composition can be taken into account in pattern recognition.

In the case of at least one thermal sensor, this sensor can detect a temperature-dependent signal from a specific compartment and/or from a package placed in the specific compartment. The corresponding measurement signal can then be forwarded to the evaluation unit, which preferably determines the probability of minimum damage based on the temperature-dependent signal. In some cases, damage to a package can lead to a rise in temperature, for example, if the damage to the package leads to an exothermic chemical reaction. In order to make more accurate predictions regarding possible damage, the probability of minimum damage can be determined based on a temperature difference determined by the evaluation unit with or without recourse to a central processing unit. The temperature difference in question is, in particular, that between the temperature of the package and the temperature of the corresponding compartment, or a difference between the temperatures of the corresponding compartment and the environment of the compartment system.

Alternatively or additionally, an inspection station for applying at least one predetermined inspection movement to a package may be provided in at least one compartment assigned to the at least one sensor. The inspection movement can then induce an acoustic and/or mechanical response signal from the package, wherein the response signal may then depend on possible damage to the package, in particular the packaging material and/or the packaged goods. In this case, at least one acoustic and/or mechanical sensor is assigned to the at least one compartment. This at least one sensor is then configured to record response signals which can be transferred to the evaluation unit. The evaluation unit can then determine the probability of minimum damage with or without recourse to a central processing unit based on pattern recognition of the recorded response signals. In this case, too, a series of similar response signals from packages with significant damage are first recorded, based on which patterns indicating damage can be identified. The recognition of corresponding patterns can be carried out using artificial intelligence. The recognition of corresponding patterns in the current response signals can also be supported by the use of artificial intelligence as required.

In principle, the evaluation unit can be configured with or without recourse to a central processing unit to perform pattern recognition based on a plurality of previously empirically determined correlations between noises, images, and/or response signals and possible damage to associated packages, packaged goods, and/or packaging materials. The basic principles are independent of the type of sensor used and the corresponding measurement signal or response signal. However, certain differences may still exist.

In order to generate suitable response signals, the inspection station for applying the inspection movement to the package may comprise at least one base plate supporting the package. This base plate may be configured so that it can be moved in at least one spatial direction and/or pivoted around at least one spatial direction. This allows very specific inspection movements to be generated in order to induce specific response signals. In addition, a large number of different inspection movements can be set in this way. Which inspection movement is applied to a package can then depend on a response signal previously recorded on the same package and/or on another measurement signal from a sensor assigned to the compartment. It has therefore proven to be expedient for the inspection station to be configured in such a way that the inspection movement, in particular the frequency and/or amplitude of the inspection movement, is adapted in a predetermined manner to the respective package depending on the response signal previously determined for the same package and/or depending on the type, size, and/or condition of the package.

When we talk about artificial intelligence in this context, we are referring in particular to systems that output information, for example, concerning pattern recognition and/or the probability of minimum damage to a package, the determination of which is based on computer-implemented processing or decision patterns that have been generated in advance in a learning phase based on large amounts of data. In this context, we refer to “machine learning” and “deep learning” as a subform of “machine learning.” These methods are well known and therefore do not need to be discussed in detail here. Experts can apply these methods, as well as artificial intelligence systems, based on their specialist knowledge and adapt them to the application in question, taking into account the present description. Due to the relationships explained above, the information output by artificial intelligence systems in response to specific queries or input information cannot be predicted solely through programming, configuration, and parameterization. At best, such a prediction can be made based on the data used to train the system. Artificial intelligence in the present sense will therefore preferably make use of a database of considerable size.

When referring to the transmission of information to a user's communication device, in particular a mobile device, this communication can take place via Bluetooth, SMS, email, web interface, messenger service, or app, for example. The mobile communication device can be a mobile phone or another handheld device or handheld computer. Such devices are generally known from the prior art.

### BRIEF DESCRIPTION OF THE DRAWINGS

The terms Fig., Figs., Figure, and Figures are used interchangeably in the specification to refer to the corresponding figures in the drawings.

The invention is explained in more detail below with reference to a drawing that is merely an exemplary embodiment. In the drawing

FIG. 1 shows a compartment system according to the invention in a schematic perspective view,

FIG. 2 shows a compartment of the compartment system from FIG. 1 in a schematic perspective view,

FIG. 3 shows the compartment from FIG. 2 in a schematic sectional view from the side, and

FIG. 4 shows the inspection station of the compartment from FIG. 2 in a schematic representation.

### DESCRIPTION OF THE INVENTION

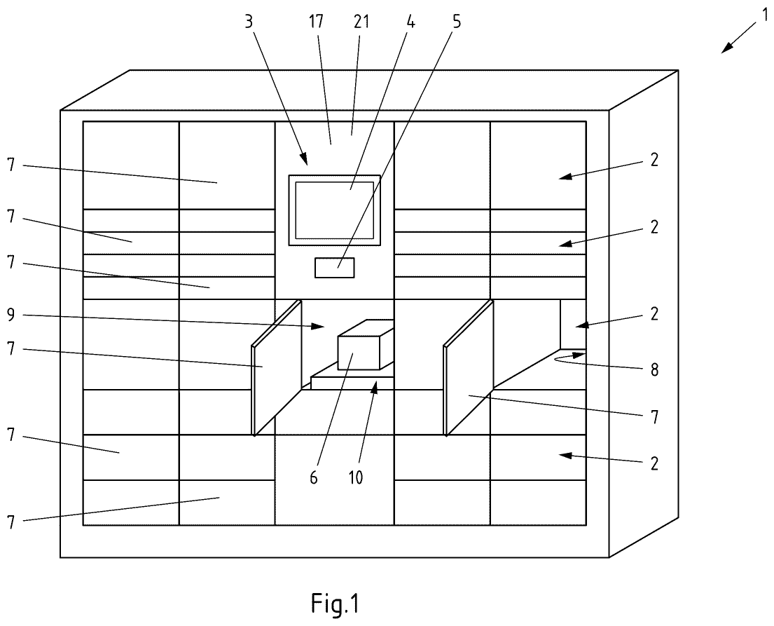

FIG. 1 shows a compartment system 1 in the style of a parcel station with a plurality of compartments 2 and an operating terminal 3. The operating terminal 3 comprises a display 4 with a touchscreen, via which inputs can be made to the compartment system 1. A scanner 5 is also provided, for example, to scan QR codes for the purpose of verifying authorization. When a user or operator presents a specific QR code to the scanner 5, scanning this QR code can cause a compartment 2 of the compartment system 1 to open.

Compartment 2 may be empty so that a package 6 can be inserted, or compartment 2 may contain a package 6 so that the user or operator of compartment system 1 can remove the package 6 from compartment 2.

The individual compartments 2 are of different sizes and are each provided with a flap 7, which can also be understood as a door. Two of the compartments 2 are shown with the associated flap 7 in a release position, in which the compartment 2 is released for inserting and removing packages 6. From the release position, the flaps 7 can be moved to a closed position shown for the other compartments 2, in which the flaps 7 close the compartments 2 so that no packages 6 can be inserted into or removed from the compartments 2. The compartments 2 are also equipped with a locking device 8 with which the flaps 7 can be locked in the closed position. However, with the appropriate authorization, the flaps 7 can also be unlocked again in order to move the flaps 7 into the release position.

The preferred compartment system 1 shown here has an inspection station 10 in a central compartment 9, where a package 6 to be placed in compartment system 1 is first checked for possible damage. Once the inspection has been completed, the package 6 can then be placed in another compartment 2. The package 6 remains there until it is collected from compartment system 1 again. In principle, several compartments 2 could also be equipped with an inspection station 10. It would also be conceivable to equip all compartments 2 with an inspection station 10. In this case, the package 6 could remain in the corresponding compartment 2 and would not necessarily have to be placed in another compartment 2 afterwards. However, the compartment system 1 would then be significantly more complex to manufacture than the compartment system 1 shown in FIG. 1.

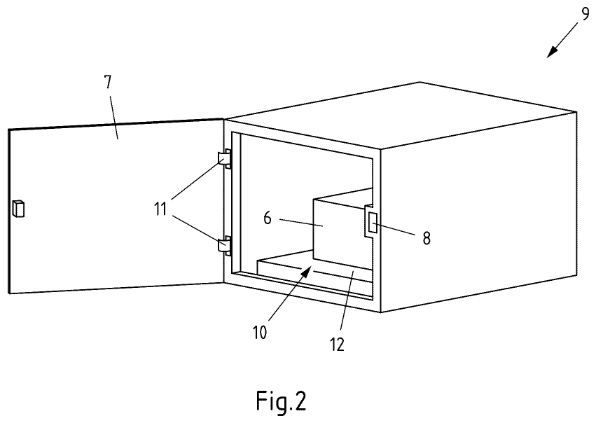

The central compartment 9 with the inspection station 10 is shown in FIG. 2. The compartment 9 has a flap 7 which can be pivoted back and forth via lateral hinges 11 between the shown release position and a closing position which closes compartment 9. In the closed position, the flap 7 can be locked with a locking device 8. The compartment 9 shown and preferred in this respect has an adjustable base plate 12 on which a package 6 to be inserted is placed.

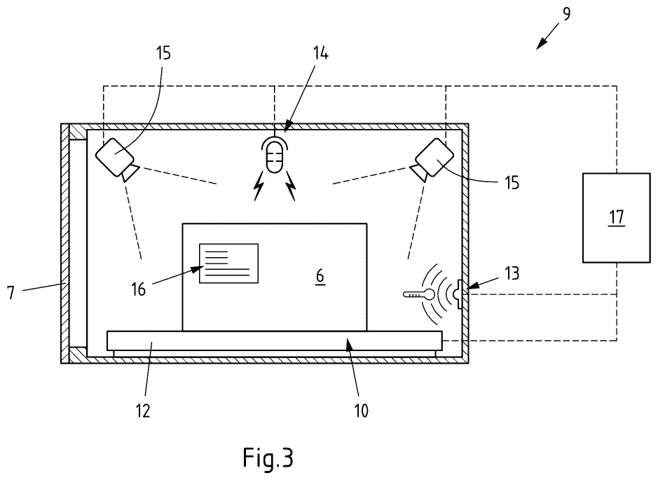

In addition, as shown schematically in FIG. 3, several sensors 13, 14, 15 are also assigned to the compartment 9. According to FIG. 3, these are a thermal sensor 13 in the form of a thermometer, an acoustic sensor 14 in the form of a microphone, and optical sensors 15, which form a scanner for scanning the inserted package 6. In principle, fewer or more sensors 13, 14, 15, as well as other sensors, may also be provided.

The optical sensors 15 can be used to determine the size, type, and/or condition of the package 6. For example, a compartment 2 of sufficient size can be selected in which the package 6 can be placed in the central compartment 9 after it has been inspected for damage. In addition, address information 16 on the package 6 can be recorded, for example. The optical sensors 15 are also used to determine whether the package 6 shows any unusual deformations. These can indicate significant damage. In order to determine whether a deformation of the package 6 indicates minimum damage to the package 6, the images from the optical sensors 15 of the deformation can be subjected to pattern recognition by the evaluation unit 17 of the compartment system 1 connected to the sensors 13, 14, 15. Patterns of deformations of packages 6 with a minimum deformation are then searched for in the images from the optical sensors 15. If such patterns are found, this may also indicate minimum damage to the package 6 currently being examined.

Minimum damage may also be indicated if the thermal sensor 13 detects an increased temperature of the package 6. This may occur, for example, because the goods packed in a packaging material are damaged, triggering an exothermic reaction. The acoustic sensor 14 can be used to record noises when the package 6 is placed in the compartment 9. For example, a clinking sound can be detected, which may indicate damage to a package, in particular to the packaged goods.

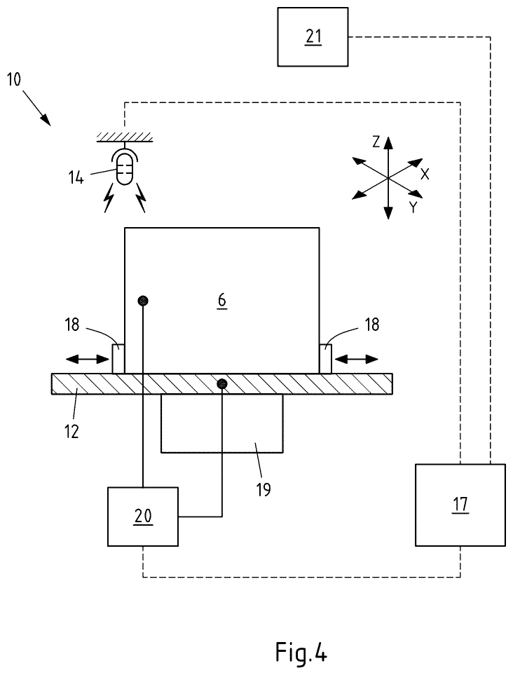

In order to be able to make a more accurate statement about possible damage to the packaging material and/or the packaged goods of a package 6, the inspection station 10 has an adjustable base plate 12. The inspection station 10 is shown schematically in FIG. 4.

Adjustable holders 18 are attached to the base plate 12, which can be brought into contact with packages 6 of different sizes located on the base plate 12 in order to hold the corresponding package 6 on the base plate 12. The base plate 12 can be moved translationally in the three spatial directions (x, y, and z directions) by means of a drive device 19. In addition, the base plate 12 can be pivoted by means of the drive device 19 around the three spatial directions (x, y, and z directions), if necessary overlapping with a corresponding translational movement of the base plate 12. The movement transmitted to the packages 6 in this way is referred to as the inspection movement.

The inspection movement thus impressed upon the packages 6 induces, at least potentially, a response signal which may be of an acoustic and/or mechanical nature. The acoustic response signal is preferably generated during the transmission of the inspection movement to the package 6 and picked up by the acoustic sensor 14, while a mechanical response signal can be generated after the inspection movement if necessary, when the response signal cannot be impaired by further movements of the package 6. If necessary, the acoustic sensor 14 can be set so that it only detects the volume of the response signal of certain sound frequencies or certain sound frequency bands. In many cases, only such information will be significant for assessing whether the respective package 6, in particular the packaged goods, is damaged or not. If necessary, this information can also be used to assess the extent to which the package 6, in particular the packaged goods, is damaged. This can then be specified as the degree of damage.

The mechanical response signal can be detected by at least one mechanical sensor 20, which records the movement of the movably mounted base plate 12 and/or the movement of the package 6. A movable mounting of the base plate 12 after the inspection movement has been applied allows the base plate 12 and thus the package 6 to oscillate or similar. However, it may also be provided that the base plate 12 is fixed after the inspection movement has been transmitted to the package 6 in order to be able to detect only the oscillation or the like of the package 6 alone with the at least one mechanical sensor 20. In this way, for example, the vibration, inertia, deflection, and/or force transmitted from the base plate 12 and/or the package 6 to the mechanical sensor 20 can be detected. This is done as required in a direction- and/or time-dependent manner in order to be able to record a response signal with a higher degree of significance.

The inspection movement applied to a specific package 6 can be selected based on the type, size, and/or condition of the package 6. The type, size, and/or condition can be determined based on the image of the at least one optical sensor 15 of the package 6, as described above.

Alternatively or additionally, a first inspection movement is applied to a package 6 and the at least one response signal is recorded. From this, information about the packaged goods packed in the packaging material of the package 6 or the potential damage can be obtained in order to specifically select a second inspection movement, which is then applied to the package 6. It is even conceivable to select a further inspection movement based on this second response signal and to apply this to the package 6 as well in order to obtain yet another response signal. The corresponding selection of an inspection movement is made by the evaluation unit 17, to which the response signals are forwarded.

At least one response signal recorded on a package 6 is subjected to pattern recognition in the evaluation unit 17, to which the response signal is forwarded from the at least one acoustic and/or mechanical sensor 14, 20. The response signal can be compared with a plurality of previously empirically determined response signals for which the damage or the degree of damage to the packaged goods 6 is documented. Similar response signals can then be used to infer similar damage or degrees of damage. However, a complete comparison of the response signals is not necessary. It is sufficient to search the newly recorded response signal for patterns that are characteristic of certain types of damage to packages 6. Artificial intelligence can be used to identify these patterns. Artificial intelligence can also be used to determine possible damage by comparing a new response signal with previously known patterns that indicate specific damage.

All that needs to be assessed is whether there is a sufficient probability of minimum damage occurring, above which the package 6 in question must be handled differently than if there were no suspicion of damage to the package 6. It is understood that in many cases this can only be determined with limited accuracy. However, the advantages of the invention described above can still be achieved in principle.

If the evaluation unit 17 believes it has detected a sufficiently probable minimum damage to the package, the control device 21 of the compartment system 1 connected to the evaluation unit 17 is informed of this. The control device 21 then controls the compartment system 1 accordingly, i.e., depending on the probability of possible minimum damage to the package 6. This can be done in various ways.

It may be provided that the central compartment 9 is neither configured nor equipped to permanently hold a package 6, but only serves to examine it for possible damage. If the package 6 is probably not damaged, the control device 21 opens an empty compartment 2 into which the package 6 can be placed. However, if the package 6 is considered to be minimally damaged, the control device 21 can refrain from opening an empty compartment 2. The damaged package 6 can then not be placed in the compartment system 1 for collection and/or onward transport. Alternatively, the control device 21 can prevent an open compartment 2 from being closed with a flap 7 or the flap 7 from being locked in the closed position. The damaged package 6 cannot then be placed in the compartment system 1 in the usual manner for collection and/or further transport.

In both cases, the compartment system 1 simply refuses to accept the package 6 because it seems nonsensical to transport a damaged package 6 further and/or have it picked up by the user. The fact that the package 6 is refused due to suspected minor damage can be shown to the user on the display 4 of the operating terminal 3. Alternatively, the user may receive a corresponding message on their mobile phone or a mobile communication device.

The user can then be given the option of forcing further transport and/or collection, as if the package 6 were undamaged. However, this may be subject to the user agreeing to higher shipping costs or a lower sum insured. In principle, the user can be an operator of compartment system 1 or a user of compartment system 1. When the operator places a package 6 in compartment system 1, the user for whom the package 6 is intended can decide, if necessary, whether to collect the package 6 despite the suspected damage or to return it directly. Since the user is not on site when the package 6 is placed in the compartment system 1, a notification is sent to the user. In order to encourage the user to collect the package 6, they can be offered a higher sum insured and/or lower shipping costs for the package 6.

If a user wants to place a package 6 in the compartment system 1 that the evaluation unit 17 considers to be very likely to be damaged to a minimum extent, the user can be shown a selection of options on the display 4, from which the user must then choose one option. The options may also include higher shipping costs or a lower sum insured for the package.

### LIST OF REFERENCE SIGNS

1 compartment system
2 compartment
3 operating terminal
4 display
5 scanner
6 package
7 flap
8 locking device
9 central compartment
10 inspection station
11 hinge
12 base plate
13 thermal sensor
14 acoustic sensor
15 optical sensor
16 address information
17 evaluation unit
18 holder
19 drive device
20 mechanical sensor
21 control device

1. A compartment system with a plurality of compartments for inserting and removing packages and a plurality of flaps that can be adjusted between a closed position for closing the respective associated compartment and a release position for releasing the respective associated compartment to insert and remove packages,
wherein
at least one sensor for detecting at least one measurement signal relating to the package placed in the compartment-is assigned to at least one compartment, in that the sensor is connected to an evaluation unit for estimating the probability of possible minimum damage to the package placed in the compartment based on the detected measurement signal, and in that the evaluation unit is connected to a control device for controlling the compartment system depending on the probability of possible minimum damage to the package.

2. The compartment system according to claim 1,
wherein
the control device is configured to communicate information to the operator of the compartment system based on the probability of possible minimum damage to a package, and in that, preferably, the compartment system is configured to display this information on an indicator, for example display, of the compartment system and/or to send it to a communication device, in particular a mobile communication device, of the operator.

3. The compartment system according to claim 1,
wherein
the control device is configured to communicate information to the user based on the probability of possible minimum damage to a package, and in that, preferably, the compartment system is configured to display this information on an indicator of the compartment system and/or send it to a communication device, in particular a mobile communication device, of the user.

4. The compartment system according to claim 1,
wherein
the control device is configured to reject the acceptance of the at least one package by the compartment system based on the probability of possible minimum damage to a package, and in that, preferably, the control device is configured to block the locking of a flap assigned to a specific compartment and/or to block or cause the unlocking of a flap assigned to a specific compartment based on the probability of possible minimum damage to a package.

5. The compartment system according to claim 1,
wherein
the control device is configured to effect the locking and/or unlocking of a flap assigned to a specific compartment only depending on at least one predetermined action of a user detectable by the control device.

6. The compartment system according to claim 5,
wherein
the action of the user detectable by the control device is an input at an operating unit of the compartment system and/or a transmission, in particular wireless, of information to the control device and/or
in that the action of the user detectable by the control device is a confirmation of a, in particular by the compartment system, suggested handling of the package or a selection of several, in particular by the compartment system, suggested options.

7. The compartment system according to claim 1,
wherein
the at least one sensor is an acoustic sensor, in particular a microphone, an electromagnetic sensor, an optical sensor, in particular a camera, a mechanical sensor, a thermal sensor, in particular a thermometer, and/or a humidity sensor.

8. The compartment system according to claim 7,
wherein
the at least one acoustic sensor detects noises generated when a package is placed in a specific compartment of the compartment system and forwards these to the evaluation unit, and in that, preferably, the evaluation unit determines the probability of minimum damage based on pattern recognition of the recorded noises.

9. The compartment system according to claim 7,
wherein
the at least one optical sensor generates images of a package placed in a specific compartment of the compartment system and forwards these to the evaluation unit, and in that, preferably, the evaluation unit determines the probability of minimum damage based on pattern recognition of the images.

10. The compartment system according to claim 9,
wherein
an optical sensor is a scanner for scanning the packages, in particular in the form of a six-sided scanner and/or a line scanner, in particular an RGB line scanner, and/or a volume scanner, and is assigned to the at least one compartment, and in that, preferably, the evaluation unit is configured to determine the type, size, and/or condition of the package to be handled based on the images from the scanner.

11. The compartment system according to claim 7,
wherein
the at least one thermal sensor determines a temperature-dependent signal from a specific compartment and/or from a package placed in the specific compartment and forwards it to the evaluation unit, and in that, preferably, the evaluation unit determines the probability of minimum damage based on the temperature-dependent signal, in particular based on a temperature difference determined by the evaluation unit, in particular between the package and the compartment or between the compartment and the environment of the compartment system.

12. The compartment system according to claim 7,
wherein
in at least one compartment assigned to the at least one sensor, there is an inspection station for applying at least one predetermined inspection movement to a package in order to indicate acoustic and/or mechanical response signals depending on possible damage to the package, in particular packaging material and/or packaged goods, in that the at least one acoustic and/or mechanical sensor assigned to the compartment is configured to record the response signals, and in that the evaluation unit determines the probability of minimum damage based on pattern recognition of the recorded response signal.

13. The compartment system according to claim 7,
wherein
the evaluation unit is configured to perform pattern recognition based on a plurality of previously empirically determined correlations between noises, images and/or response signals and possible damage to associated packages, packaged goods and/or packaging materials.

14. The compartment system according to claim 12,
wherein
the inspection station for applying the inspection movement to the package has at least one base plate supporting the package, and in that the base plate is configured to be moved in at least one spatial direction and/or pivoted about at least one spatial direction.

15. The compartment system according to claim 12,
wherein
the inspection station is configured to apply the inspection movement, in particular the frequency and/or the amplitude of the inspection movement, to the respective package in a predetermined manner depending on the response signal previously determined for the same package and/or depending on the type, size, and/or condition of the package.
